(19) United States
(12) Patent Application Publication
(10) Pub. No.: US 2024/0124317 A1
(43) Pub. Date: Apr. 18, 2024

(54) PROCESSES OF PRODUCING MESOPOROUS BETA ZEOLITES

(71) Applicant: Saudi Arabian Oil Company, Dhahran (SA)

(72) Inventors: Aaron Chi Akah, Dhahran (SA); Veera Venkata Ramakrishna Tammana, Dhahran (SA)

(73) Assignee: Saudi Arabian Oil Company, Dhahran (SA)

(21) Appl. No.: 17/964,155

(22) Filed: Oct. 12, 2022

(51) Int. Cl. C01B 39/46; B01J 29/70; C10G 47/02; C10G 47/30

(52) U.S. Cl. CPC C01B 39/46; B01J 29/7007; C10G 47/02; C10G 47/30; C01P 2004/61; C01P 2006/12; C01P 2006/14; C01P 2006/16

(57) ABSTRACT

A process of producing a mesoporous beta zeolite includes mixing a crystalline beta zeolite with one or more solvents, cetyltrimethylammonium bromide, and metal hydroxide to produce a solution, heating the solution at a temperature of from 50° C. to 150° C. to convert the crystalline beta zeolite to a non-crystalline material with reduced silica content relative to the crystalline beta zeolite, cooling the solution to a temperature of from 25° C. to 40° C., adjusting the pH of the solution to from 8 to 10 by adding an acid, and aging the solution at a temperature of from 50° C. to 150° C. for a time period sufficient to crystalize the non-crystalline material to produce beta zeolite particles.

### BACKGROUND

### Field

The present disclosure generally relates to zeolites and, more particularly, to processes for producing zeolites.

### Technical Background

Ethylene, propene, butene, butadiene, and aromatics compounds such as benzene, toluene and xylenes are basic intermediates for a large proportion of the petrochemical industry. They are usually obtained through the thermal cracking (or steam pyrolysis) of petroleum gases and distillates such as naphtha, kerosene or even gas oil. These compounds are also produced through refinery fluidized catalytic cracking (FCC) process where classical heavy feedstocks, such as gas oils or residues, are converted. Typical FCC feedstocks range from hydrocracked bottoms to heavy feed fractions such as vacuum gas oil and atmospheric residue; however, these feedstocks are limited. The second most important source for propene production is currently refinery propene from FCC units. With the ever-growing demand, FCC unit owners look increasingly to the petrochemicals market to boost their revenues by taking advantage of economic opportunities that arise in the propene market.

The worldwide increasing demand for light olefins remains a major challenge for many integrated refineries. In particular, the production of some valuable light olefins such as ethylene, propene, and butene has attracted increased attention as pure olefin streams are considered the building blocks for polymer synthesis. The production of light olefins depends on several process variables like the feed type, operating conditions, and the type of catalyst.

Despite the options available for producing a greater yield of propene and other light olefins, intense research activity in this field is still being conducted. These options include developing more selective catalysts for the process, and enhancing the configuration of the process in favor of more advantageous reaction conditions and yields. In particular, due to their excellent stability, strong acidity, and regular pore sizes, zeolites are of great importance to industrial catalysis in petrochemical and chemical conversion processes.

### SUMMARY

Accordingly, ongoing needs exist for processes of producing mesoporous beta zeolite s that are suitable for chemical processing. Embodiments of the present disclosure meet this need by producing mesoporous beta zeolites, as described herein. The presently described processes produce the mesoporous beta zeolites by processes that include mixing a crystalline beta zeolite with one or more solvents, cetyltrimethylammonium bromide (CTAB), and metal hydroxide to produce a solution, and adjusting a pH of the solution to from 8 to 10 by adding an acid. In some embodiments, the mesoporous beta zeolites produced by the presently described processes may have mesopores and micropores; and the mesopores and micropores may be more uniform as compared to conventional mesoporous beta zeolites. Such mesoporous beta zeolites, prepared by the processes disclosed herein, may be particularly useful in steam enhanced catalytic cracking systems and capable of direct conversion of crude oil into light olefins with increased yield of light olefins such as at least one of ethylene, propylene, and butylene. The mesoporous beta zeolite prepared by the process disclosed herein may withstand high hydrothermal conditions, while retaining its activity and selectivity.

According to one or more aspects of the present disclosure, a process of producing a mesoporous beta zeolite may include mixing a crystalline beta zeolite with one or more solvents, cetyltrimethylammonium bromide (CTAB), and metal hydroxide to produce a solution, heating the solution at a temperature of from 50° C. to 150° C. to convert the crystalline beta zeolite to a non-crystalline material with reduced silica content relative to the crystalline beta zeolite, cooling the solution to a temperature of from 25° C. to 40° C., adjusting a pH of the solution to from 8 to 10 by adding an acid, and aging the solution at a temperature of from 50° C. to 150° C. for a time period sufficient to crystalize the non-crystalline material to produce beta zeolite particles.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a flowchart for a process of producing a mesoporous beta zeolite, according to one or more embodiments shown and described in this disclosure;

FIG. 2 is a generalized schematic diagram of a fixed-bed reaction system, according to one or more embodiments described in this disclosure; and

FIG. 3 depicts yield analyses for Example 4.

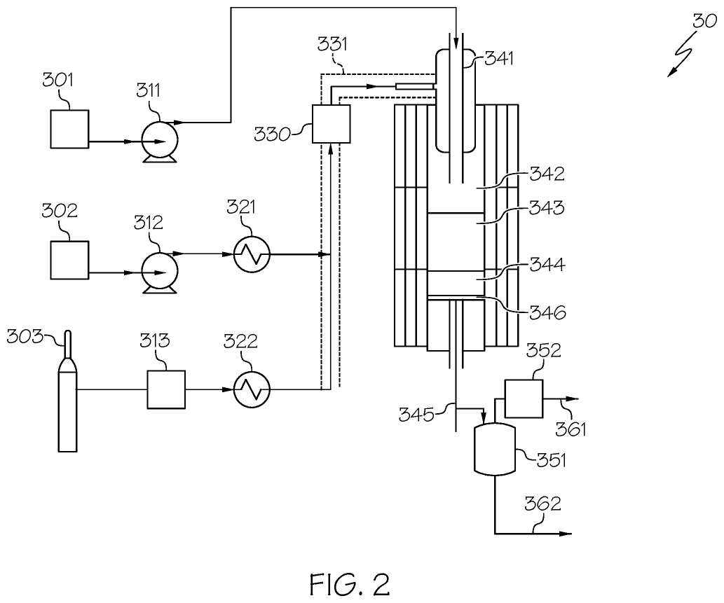

For the purpose of describing the simplified schematic illustration and description of FIG. 2, the numerous valves, temperature sensors, electronic controllers, and the like that may be employed and well known to those of ordinary skill in the art of certain chemical processing operations are not included. Further, accompanying components that are often included in chemical processing operations, such as, for example, air supplies, heat exchangers, surge tanks, catalyst hoppers, or other related systems are not depicted. It would be known that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines that may serve to transfer process steams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows that do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-proc e s se d feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that two or more process streams are “mixed” or “combined” when two or more lines intersect in the schematic flow diagram of FIG. 2. Mixing or combining may also include mixing by directly introducing both streams into a like reactor, separation device, or other system component. For example, it should be understood that when two streams are depicted as being combined directly prior to entering a separator or reactor, that in some embodiments the streams could equivalently be introduced into the separator or reactor and be mixed in the reactor.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DFSCRIPTION

Disclosed herein are processes for forming mesoporous beta zeolites that, in some embodiments, may be useful in steam enhanced fluid catalytic cracking reactions of hydrocarbons. The processes may generally include mixing a crystalline beta zeolite with cetyltrimethylammonium bromide (CTAB), and metal hydroxide, converting the crystalline beta zeolite to a non-crystalline material with reduced silica content, cooling the solution, adjusting a pH of the solution, and aging the solution to produce beta zeolite particles. Particular non-limiting embodiments of such processes are disclosed herein.

As used in this disclosure, the term “catalyst” may refer to any substance that increases the rate of a specific chemical reaction.

As used in this disclosure, the term “cracking” may refer to a chemical reaction where a molecule having carbon-carbon bonds is broken into more than one molecule by the breaking of one or more of the carbon-carbon bonds; where a compound including a cyclic moiety, such as an aromatic, is converted to a compound that does not include a cyclic moiety; or where a molecule having carbon-carbon double bonds are reduced to carbon-carbon single bonds. Some catalysts may have multiple forms of catalytic activity, and calling a catalyst by one particular function does not render that catalyst incapable of being catalytically active for other functionality.

As used in this disclosure, the term “particle size” of crystalline beta zeolite or mesoporous beta zeolite may refer to a greatest distance between two points located on crystalline beta zeolite or mesoporous beta zeolite. For example, the particle size of a spherical particle would be its diameter. In other shapes, the particle size is measured as the distance between the two most distant points of the same particle, where these points may lie on outer surfaces of the particle. The particle size may be determined by scanning electron microscopy (SEM).

As used in this disclosure, the term “crystal size” of crystalline beta zeolite or mesoporous beta zeolite may refer to be a length of the coherent scattering domain in a direction orthogonal to the set of lattice planes which give rise to the reflection. The crystal size may be calculated from XRD.

As used in this disclosure, the term “pore size” of crystalline beta zeolite or mesoporous beta zeolite may refer to the pore size determined by Niercury Intrusion Porosimetry.

As used in this disclosure, the term “microporous” may refer to a material, such as a beta zeolite, having pores with an average pore size of from 0.1 nanometers (nm) to 2 nm.

As used in the present disclosure, the term “mesoporous” may refer to a material, such as a beta zeolite, having pores with an average pore size of from 2 nm to 50 nm.

As used in the present disclosure, the term “crude oil” may refer to a mixture of petroleum liquids and gases, including impurities, such as sulfur-containing compounds, nitrogen-containing compounds, and metal compounds, extracted directly from a subterranean formation or received from a desalting unit without having any fractions, such as naphtha, separated by distillation.

As used in the present disclosure, the term “reactor” may refer to a vessel or series of vessels in which one or more chemical reactions may occur between one or more reactants in the presence of one or more catalysts. For example, a reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors.

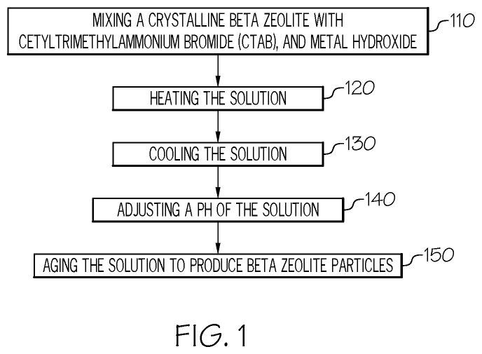

Embodiments of the present disclosure are directed to processes of producing a mesoporous beta zeolite. FIG. 1 depicts a flowchart for a process of producing a mesoporous beta zeolite, according to one or more embodiments shown and described in this disclosure. FIG. 1 includes steps 110, 120, 130, 140, and 150, where the steps may be performed in that recited order (i.e., 110 prior to 120, 120 prior to 130, 130 prior to 140, and 140 prior to 150). Other steps may additionally be included in the methods described herein, and it should not be construed that the processes described herein are limited to only the steps of FIG. 1.

Referring to FIG. 1, in step 110, a crystalline beta zeolite is mixed with one or more solvents, cetyltrimethylammonium bromide (CTAB), and metal hydroxide to produce a solution. In some embodiments, the mixing step include mixing the crystalline beta zeolite with metal hydroxide, and then adding CTAB into a mixture of the crystalline beta zeolite with metal hydroxide. Without being limited by any particular theory, it is believed the mixing step may evenly disperse the crystalline beta zeolite, CTAB, and metal hydroxide. Mixing may include one or more of stirring, swirling, vortexing, shaking, sonicating, homogenizing, blending, or the like.

The crystalline beta zeolite may have an average particle size of from 0.01 micrometers (μm) to 5.0 μm, from 0.01 μm to 3.0 μm, from 0.01 μm to 2.0 μm, from 0.01 μm to 1.5 μm, or from 0.01 μm to 1.4 μm. The particle size may be calculated from XRD. The particle of crystalline beta zeolite may comprise one or more crystals. The crystal may comprise one or more unit cells.

The crystalline beta zeolite may have an average crystal size of 0.05 μm to 5.0 μm, from 0.05 μm to 3.0 μm, from 0.05 μm to 2.0 μm, from 0.05 μm to 1.5 μm, from 0.05 μm to 1.4 μm, 0.1 μm to 5.0 μm, from 0.1 μm to 3.0 μm, from 0.1 μm to 2.0 μm, from 0.1 μm to 1.5 μm, or from 0.1 μm to 1.4 μm. The crystal size may be calculated from XRD.

The crystalline beta zeolite may have an average pore size of from 0.5 nanometers (nm) to 3.0 nm, from 0.5 nm to 2.0 nm, from 0.5 nm to 1.0 nm, from 0.5 nm to 0.75 nm, from 0.5 nm to 0.74 nm, from 0.56 nm to 3.0 nm, from 0.56 nm to 2.0 nm, from 0.56 nm to 1.0 nm, from 0.56 nm to 0.75 nm, or from 0.56 nm to 0.74 nm. The pore size may be determined using the Mercury Intrusion Porosimetry.

The crystalline beta zeolite may have a molar ratio of silica (SiO₂) to alumina (Al₂O₃) of greater than or equal to 10, greater than or equal to 20, or even greater than or equal to 30. The crystalline beta zeolite may have a molar ratio of SiO₂ to Al₂O₃ of less than or equal to 400, such as less than or equal to 350, or even less than or equal to 300. The crystalline beta zeolite may have a molar ratio of SiO₂ to Al₂O₃ of from 10 to 400, from 10 to 350, from 10 to 300, from 20 to 400, from 20 to 350, from 20 to 300, from 30 to 400, from 30 to 350, from 30 to 300, from 10 to 70, from 20 to 60, from 30 to 50, from 250 to 400, from 280 to 350, or from 300 to 320.

The metal hydroxide may include a single metal hydroxide species, or a combination of two or more metal hydroxide chemical species. In embodiments, the metal hydroxide comprises at least one alkali metal hydroxide, at least one alkali earth metal hydroxide, or combinations thereof. The metal hydroxide may comprise lithium hydroxide (LiOH), sodium hydroxide (NaOH), potassium hydroxide (KOH), rubidium hydroxide (RbOH), magnesium hydroxide (Mg(OH)₂), calcium hydroxide (Ca(OH)₂), strontium hydroxide (Sr(OH)₂), barium hydroxide (Ba(OH)₂), or combinations thereof.

In one or more embodiments, the metal hydroxide may be in a solution. The metal hydroxide solution may have a metal hydroxide concentration from 0.01 moles per liter (M) to 10 M, such as from 0.01 M to 5 M, from 0.01 M to 3 M, from 0.01 M to 1 M, from 0.05 M to 1 M, from 0.05 M to 0.8 M, from 0.05 M to 0.5 M, or from 0.1 M to 0.4 M.

Still referring to FIG. 1, in step 110, the crystalline beta zeolite and the metal hydroxide may be mixed with cetyltrimethylammonium bromide (CTAB). CTAB is a surfactant. In particular, when the solution including the crystalline beta zeolite, the metal hydroxide, and CTAB, the CTAB is heated to produce a non-crystalline material, the CTAB may reduce silica content of the crystalline beta zeolite. Thus, the non-crystalline material may have reduced silica content relative to the crystalline beta zeolite.

CTAB may be included in a CTAB solution. The CTAB solution may have greater than or equal to 1 wt. %, greater than or equal to 2 wt. %, or greater than or equal to 3 wt. % of CTAB. The CTAB solution may have less than or equal to 10 wt. %, less than or equal to 8 wt. %, less than or equal to 7 wt. %, or less than or equal to 6 wt. % of CTAB. The CTAB solution may have from 1 wt. % to 10 wt. %, from 1 wt. % to 8 wt. %, from 1 wt. % to 7 wt. %, from 1 wt. % to 6 wt. %, from 2 wt. % to 10 wt. %, from 2 wt. % to 8 wt. %, from 2 wt. % to 7 wt. %, from 2 wt. % to 6 wt. %, from 3 wt. % to 10 wt. %, from 3 wt. % to 8 wt. %, from 3 wt. % to 7 wt. %, or from 3 wt. % to 6 wt. % of CTAB.

Still referring to FIG. 1, in step 120, the solution may be heated at a temperature of from 50° C. to 150° C. to convert the crystalline beta zeolite to a non-crystalline material with reduced silica content relative to the crystalline beta zeolite. In the heating step, the crystalline beta zeolite may be disintegrated. The term “disintegrated” may refer that the siloxane bonds (silicate groups) of the crystalline beta zeolite are broken.

The solution may be heated at a temperature of greater than or equal to 50° C., greater than or equal to 60° C., greater than or equal to 70° C., or greaterthan or equal to 80° C. The solution may be heated at a temperature of less than or equal to 150° C., less than or equal to 140° C., less than or equal to 130° C., or less than or equal to 120° C. The solution may be heated at a temperature of from 50° C. to 150° C., from 50° C. to 140° C., from 50° C. to 130° C., from 50° C. to 120° C., from 60° C. to 150° C., from 60° C. to 140° C., from 60° C. to 130° C., from 60° C. to 120° C., from 70° C. to 150° C., from 70° C. to 140° C., from 70° C. to 130° C., from 70° C. to 120° C., from 80° C. to 150° C., from 80° C. to 140° C., from 80° C. to 130° C., or from 80° C. to 120° C.

Still referring to FIG. 1, in step 130, the heated solution may be cooled to a temperature of from 25° C. to 40° C. The solution may be cooled at a temperature of greater than or equal to 0° C., greater than or equal to 10° C., greater than or equal to 20° C., or greater than or equal to 25° C. The solution may be cooled at a temperature of less than or equal to 50° C., less than or equal to 45° C., less than or equal to 40° C., or less than or equal to 30° C. The solution may be cooled at a temperature of from 0° C. to 50° C., from 0° C. to 45° C., from 0° C. to 40° C., from 0° C. to 30° C., from 10° C. to 50° C., from 10° C. to 45° C., from 10° C. to 40° C., from 10° C. to 30° C., from 20° C. to 50° C., from 20° C. to 45° C., from 20° C. to 40° C., from 20° C. to 30° C., from 25° C. to 50° C., from 25° C. to 45° C., or from 25° C. to 40° C.

Still referring to FIG. 1, in step 140, the pH of the solution may be adjusted to from 8 to 10 by adding an acid. In the step of adjusting a pH of the solution, CTAB, which is already present in the solution, takes a circular micellar form.

The acid may include dilute sulfuric acid, nitric acid, acetic acid, citric acid, oxalic acid, or combinations thereof. In some embodiments, the acid may have from 0.1 Normality (N) to 5 N, from 0.1 N to 4 N, from 0.1 N to 3 N, from 0.5 N to 5 N, from 0.5 N to 4 N, from 0.5 N to 3 N, from 1 N to 5 N, from 1 N to 4 N, or from 1 N to 3 N.

In some embodiments, the solution may have the pH of greater than or equal to 13. The pH of the solution may be adjusted to greater than or equal to 7, greater than or equal to 8, or greater than or equal to 9. The pH of the solution may be adjusted to less than or equal to 12, less than or equal to 11, or less than or equal to 10. The pH of the solution may be adjusted to from 7 to 12, from 7 to 11, from 7 to 10, from 8 to 12, from 8 to 11, from 8 to 10, from 9 to 12, from 9 to 11, or from 9 to 10.

In some embodiments, the process of the present disclosure of producing mesoporous beta zeolites includes stirring the solution from 10 hour to 48 hours (not shown in FIG. 1). The solution may be stirred at a time period of greater than or equal to 10 hours, greater than or equal to 13 hours, greater than or equal to 17 hours, or greater than or equal to 20 hours. The solution may be stirred at a time period of less than or equal to 48 hours, less than or equal to 40 hours, less than or equal to 35 hours, or less than or equal to 30 hours. The solution may be stirred at a time period of from 10 hours to 48 hours, from 10 hours to 40 hours, from 10 hours to 35 hours, from 10 hours to 30 hours, from 13 hours to 48 hours, from 13 hours to 40 hours, from 13 hours to 35 hours, from 13 hours to 30 hours, from 17 hours to 48 hours, from 17 hours to 40 hours, from 17 hours to 35 hours, from 17 hours to 30 hours, from 20 hours to 48 hours, from 20 hours to 40 hours, from 20 hours to 35 hours, or from 20 hours to 30 hours.

Still referring to FIG. 1, in step 150, the solution may be aged at a temperature of from 50° C. to 150° C. for a time period sufficient to crystalize the non-crystalline material to produce beta zeolite particles. When the non-crystalline material is crystalized, the silica broken from the crystalline beta zeolite helps to produce a beta zeolite having uniform mesopores and micropores. In particular, a surfactant, CTAB, may act as a structure directing agent. Re-crystallisation of beta zeolite in the presence of CTAB may prevent the dissolution of the crystals and lead to almost complete recovery of the zeolite. After calcination, the surfactant moiety may be removed and the resulting voids constitute the mesopores of the mesoporous zeolite. The achievement of uniform mesoporosity is highly desirable because the mesopore quality, which encompasses size, distribution, and connectivity, helps improve stability against coke deactivation. Conventional microporous beta zeolite may inhibit access to catalytically active sites on the beta zeolite to larger molecules, which may have a molecular size equal to or greater than the average pore size of the microporous beta zeolite. The mesoporous beta zeolite produced by the presently described process may be hierarchical mesoporous beta zeolite having both uniform mesopores and micropores. With these uniform mesopores and micropores, the mesoporous beta zeolite may increase access to the large size molecules, and thereby suitable for hydrocarbon feedstocks including larger hydrocarbon molecules, such as crude oil. Also, the mesoporous beta zeolite may exhibit stability at elevated temperatures, such as temperatures greater than 500° C., and the acid sites of mesoporous beta zeolites may be compatible with hydrocracking reactions, which are helpful to break up a hydrocarbon feed or a hydrocarbon fraction into smaller molecules. The mesoporous beta zeolite, therefore, may facilitate the transport of the larger hydrocarbon molecules in crude oil to catalytic sites and reduce the diffusion limitations of these catalysts.

The solution may be aged at a temperature of greater than or equal to 50° C., greater than or equal to 60° C., greater than or equal to 70° C., or greater than or equal to 80° C. The solution may be aged at a temperature of less than or equal to 150° C., less than or equal to 140° C., less than or equal to 130° C., or less than or equal to 120° C. The solution may be aged at a temperature of from 50° C. to 150° C., from 50° C. to 140° C., from 50° C. to 130° C., from 50° C. to 120° C., from 60° C. to 150° C., from 60° C. to 140° C., from 60° C. to 130° C., from 60° C. to 120° C., from 70° C. to 150° C., from 70° C. to 140° C., from 70° C. to 130° C., from 70° C. to 120° C., from 80° C. to 150° C., from 80° C. to 140° C., from 80° C. to 130° C., or from 80° C. to 120° C. The solution may be aged at a time period of greater than or equal to 10 hours, greater than or equal to 13 hours, greater than or equal to 17 hours, or greater than or equal to 20 hours. The solution may be aged at a time period of less than or equal to 48 hours, less than or equal to 40 hours, less than or equal to 35 hours, or less than or equal to 30 hours. The solution may be aged at a time period of from 10 hours to 48 hours, from 10 hours to 40 hours, from 10 hours to 35 hours, from 10 hours to 30 hours, from 13 hours to 48 hours, from 13 hours to 40 hours, from 13 hours to 35 hours, from 13 hours to 30 hours, from 17 hours to 48 hours, from 17 hours to 40 hours, from 17 hours to 35 hours, from 17 hours to 30 hours, from 20 hours to 48 hours, from 20 hours to 40 hours, from 20 hours to 35 hours, or from 20 hours to 30 hours.

In some embodiments, the process of the present disclosure of producing mesoporous beta zeolites includes filtering the beta zeolite particles from the solution (not shown in FIG. 1).

In some embodiments, the process of the present disclosure of producing mesoporous beta zeolites includes washing the beta zeolite particles through distilled water (not shown in FIG. 1). The beta zeolite particles may be washed through distilled water to remove excess metal hydroxide and CTAB from the beta zeolite particles.

In some embodiments, the process of the present disclosure of producing mesoporous beta zeolites includes drying the beta zeolite particles at a temperature of from 50° C. to 150° C. (not shown in FIG. 1). The beta zeolite particles may be dried at a temperature of greater than or equal to 50° C., greater than or equal to 60° C., or greater than or equal to 70° C. The beta zeolite particles may be dried at a temperature of less than 200° C., less than 150° C., or less than 100° C. The beta zeolite particles may be dried at a temperature of from 50° C. to 200° C., from 50° C. to 150° C., from 50° C. to 100° C., from 60° C. to 200° C., from 60° C. to 150° C., from 60° C. to 100° C., from 70° C. to 200° C., from 70° C. to 150° C., or from 70° C. to 100° C. The solution may be dried at a time period of greater than or equal to 2 hours, greater than or equal to 4 hours, greater than or equal to 6 hours, or greater than or equal to 8 hours. The solution may be dried at a time period of less than 24 hours, less than 20 hours, less than 15 hours, or less than 12 hours. The solution may be dried at a time period of from 2 hours to 24 hours, from 2 hours to 20 hours, from 2 hours to 15 hours, from 2 hours to 12 hours, from 4 hours to 24 hours, from 4 hours to 20 hours, from 4 hours to 15 hours, from 4 hours to 12 hours, from 6 hours to 24 hours, from 6 hours to 20 hours, from 6 hours to 15 hours, from 6 hours to 12 hours, from 8 hours to 24 hours, from 8 hours to 20 hours, from 8 hours to 15 hours, or from 8 hours to 12 hours.

In some embodiments, the process of the present disclosure of producing mesoporous beta zeolites includes calcining the beta zeolite particles at a temperature of from 400° C. to 800° C. for 1 to 12 hours to remove the surfactant, such as CTAB (not shown in FIG. 1). The beta zeolite particles may be calcined at a temperature of greater than or equal to 400° C., greater than or equal to 450° C., or greater than or equal to 500° C. The beta zeolite particles may be calcined at a temperature of less than or equal to 800° C., less than or equal to 700° C., or less than or equal to 600° C. The beta zeolite particles may be calcined at a temperature of from 400° C. to 800° C., from 400° C. to 700° C., from 400° C. to 600° C., from 450° C. to 800° C., from 450° C. to 700° C., from 450° C. to 600° C., from 500° C. to 800° C., from 500° C. to 700° C., or from 500° C. to 600° C. The solution may be calcined at a time period of greater than or equal to 1 hour, greater than or equal to 3 hours, or greater than or equal to 5 hours. The solution may be calcined at a time period of less than or equal to 15 hours, less than or equal to 12 hours, less than or equal to 10 hours, or less than or equal to 8 hours. The solution may be calcined at a time period of from 1 hour to 15 hours, from 1 hour to 12 hours, from 1 hour to 10 hours, from 1 hour to 8 hours, from 3 hours to 15 hours, from 3 hours to 12 hours, from 3 hours to 10 hours, from 3 hours to 8 hours, from 5 hour to 15 hours, from 5 hour to 12 hours, from 5 hour to 10 hours, or from 5 hour to 8 hours.

Still referring to FIG. 1, in some embodiments, the process of the present disclosure of producing a mesoporous beta zeolite includes treating the beta zeolite particles with ammonium salt a temperature of from 70° C. to 90° C. for 1 to 12 hours (not shown in FIG. 1). The treating the beta zeolite particles with the ammonium salt may cause sufficient ion exchange of sodium ions with ammonium ions present in the ammonium salt to produce the mesoporous beta zeolite. The beta zeolite particles may be treated with the ammonium salt at a temperature of greater than or equal to 40° C., greater than or equal to 50° C., or greater than or equal to 60° C. The beta zeolite particles may be treated with the ammonium salt at a temperature of less than or equal to 200° C., less than or equal to 150° C., or less than or equal to 100° C. The beta zeolite particles may be treated with the ammonium salt at a temperature of from 40° C. to 200° C., from 40° C. to 150° C., from 40° C. to 100° C., from 50° C. to 200° C., from 50° C. to 150° C., from 50° C. to 100° C., from 60° C. to 200° C., from 60° C. to 150° C., or from 60° C. to 100° C. The solution may be treated with the ammonium salt at a time period of greater than or equal to 1 hour, greater than or equal to 2 hours, or greater than or equal to 3 hours. The solution may be treated with the ammonium salt at a time period of less than or equal to 12 hours, less than or equal to 10 hours, less than or equal to 9 hours, or less than or equal to 8 hours. The solution may be treated with the ammonium salt at a time period of from 1 hour to 12 hours, from 1 hour to 10 hours, from 1 hour to 9 hours, from 1 hour to 8 hours, from 2 hours to 12 hours, from 2 hours to 10 hours, from 2 hours to 9 hours, from 2 hours to 8 hours, from 3 hour to 12 hours, from 3 hour to 10 hours, from 3 hour to 9 hours, or from 3 hour to 8 hours.

In some embodiments, the treating step may include first treating the beta zeolite particles with the ammonium salt at a temperature of from 70° C. to 90° C. for 1 to 12 hours, and second treating the beta zeolite particles with the ammonium salt at a temperature of from 70° C. to 90° C. for 1 to 12 hours to produce the mesoporous beta zeolite (not shown in FIG. 1). The beta zeolite particles may be first treated with the ammonium salt at a temperature of greater than or equal to 40° C., greater than or equal to 50° C., or greater than or equal to 60° C. The beta zeolite particles may be first treated with the ammonium salt at a temperature of less than or equal to 200° C., less than or equal to 150° C., or less than or equal to 100° C. The beta zeolite particles may be first treated with the ammonium salt at a temperature of from 40° C. to 200° C., from 40° C. to 150° C., from 40° C. to 100° C., from 50° C. to 200° C., from 50° C. to 150° C., from 50° C. to 100° C., from 60° C. to 200° C., from 60° C. to 150° C., or from 60° C. to 100° C. The solution may be first treated with the ammonium salt at a time period of greater than or equal to 1 hour, greater than or equal to 2 hours, or greater than or equal to 3 hours. The solution may be first treated with the ammonium salt at a time period of less than or equal to 12 hours, less than or equal to 10 hours, less than or equal to 9 hours, or less than or equal to 8 hours. The solution may be first treated with the ammonium salt at a time period of from 1 hour to 12 hours, from 1 hour to 10 hours, from 1 hour to 9 hours, from 1 hour to 8 hours, from 2 hours to 12 hours, from 2 hours to 10 hours, from 2 hours to 9 hours, from 2 hours to 8 hours, from 3 hour to 12 hours, from 3 hour to 10 hours, from 3 hour to 9 hours, or from 3 hour to 8 hours. The beta zeolite particles may be second treated with the ammonium salt at a temperature of greater than or equal to 40° C., greater than or equal to 50° C., or greater than or equal to 60° C. The beta zeolite particles may be second treated with the ammonium salt at a temperature of less than or equal to 200° C., less than or equal to 150° C., or less than or equal to 100° C. The beta zeolite particles may be second treated with the ammonium salt at a temperature of from 40° C. to 200° C., from 40° C. to 150° C., from 40° C. to 100° C., from 50° C. to 200° C., from 50° C. to 150° C., from 50° C. to 100° C., from 60° C. to 200° C., from 60° C. to 150° C., or from 60° C. to 100° C. The solution may be second treated with the ammonium salt at a time period of greater than or equal to 1 hour, greater than or equal to 2 hours, or greater than or equal to 3 hours. The solution may be second treated with the ammonium salt at a time period of less than or equal to 12 hours, less than or equal to 10 hours, less than or equal to 9 hours, or less than or equal to 8 hours. The solution may be second treated with the ammonium salt at a time period of from 1 hour to 12 hours, from 1 hour to 10 hours, from 1 hour to 9 hours, from 1 hour to 8 hours, from 2 hours to 12 hours, from 2 hours to 10 hours, from 2 hours to 9 hours, from 2 hours to 8 hours, from 3 hour to 12 hours, from 3 hour to 10 hours, from 3 hour to 9 hours, or from 3 hour to 8 hours.

The ammonium salt may include salts that include an ammonium cation and at least one anion, such as but not limited to nitrate, chloride, carbonate, sulfate, or combinations of these. In some embodiments, the ammonium salt may include ammonium nitrate, ammonium chloride, ammonium sulfate, ammonium carbonate, or combinations thereof.

The ammonium salt may be included in an ammonium salt solution. The ammonium salt solution may have a concentration of ammonium salts of from 0.05 moles per liter (M) to 0.5 M, such as from 0.05 M to 0.4 M, from 0.05 M to 0.3 M, from 0.1 M to 0.5 M, from 0.1 M to 0.4 M, from 0.1 M to 0.3 M, from 0.2 M to 0.5 M, from 0.2 M to 0.4 M, or from 0.2 M to 0.3 M.

In step 150, the mesoporous beta zeolite particles are produced. The mesoporous beta zeolite particles may have an average particle size of from 0.1 μm to 3.0 from 0.1 μm to 2.0 from 0.1 μm to 1.1 μm, 0.2 μm to 3.0 from 0.2 μm to 2.0 from 0.2 μm to 1.1 μm, 0.4 μm to 3.0 from 0.4 μm to 2.0 or from 0.4 μm to 1.1 The particle size may be calculated from XRD.

The crystalline beta zeolite may have an average crystal size of from 0.1 μm to 2.0 from 0.1 μm to 1.5 from 0.1 μm to 1.4 from 0.1 μm to 1.2 from 0.5 μm to 2.0 from 0.5 μm to 1.5 from 0.5 μm to 1.4 from 0.5 μm to 1.2 from 0.6 μm to 2.0 from 0.6 μm to 1.5 from 0.6 μm to 1.4 or from 0.6 μm to 1.2 The crystal size may be calculated from XRD.

The mesoporous beta zeolite produced according to the previously described processes may have both mesopores and micropores. In some embodiments, the average mesopore size of the mesoporous beta zeolite may be from 2 nm to 20 nm, from 2 nm to 15 nm, from 2 nm to 10 nm, from 2 nm to 5 nm, from 2 nm to 4.5 nm, from 3 nm to 20 nm, from 3 nm to 15 nm, from 3 nm to 10 nm, from 3 nm to 5 nm, or 3 nm to 4.5 nm. In some embodiments, the average micropore size of the mesoporous beta zeolite may be from 0.01 nm to 3 nm, from 0.01 nm to 2.5 nm, from 0.01 nm to 2.0 nm, from 0.05 nm to 3 nm, from 0.05 nm to 2.5 nm, from 0.05 nm to 2.0 nm, from 0.1 nm to 3 nm, from 0.1 nm to 2.5 nm, from 0.1 nm to 2.0 nm, from 0.5 nm to 3 nm, from 0.5 nm to 2.5 nm, or from 0.5 nm to 2.0 nm.

In some embodiments, the mesoporous beta zeolite may have a total pore volume of from 0.1 cm³/g to 1.0 cm³/g, from 0.1 cm³/g to 0.85 cm³/g, from 0.1 cm³/g to 0.8 cm³/g, from 0.5 cm³/g to 1.0 cm³/g, from 0.5 cm³/g to 0.85 cm³/g, or from 0.5 cm³/g to 0.8 cm³/g as determined by Brunauer-Emmett-Teller (BET) analysis. The total pore volume of the mesoporous beta zeolite may represent the total sum of the volume of micropores and mesopores in the mesoporous beta zeolite.

The mesoporous beta zeolite may have a Brunauer-Emmett-Teller (BET) surface area of from 400 square meters per gram (m²/g) to 800 m²/g, from 400 m²/g to 750 m²/g, from 400 m²/g to 700 m²/g, from 450 m²/g to 800 m²/g, from 450 m²/g to 750 m²/g, from 450 m²/g to 700 m²/g, from 500 m²/g to 800 m²/g, from 500 m²/g to 750 m²/g, or from 500 m²/g to 700 m²/g.

The mesoporous beta zeolite may have a mesopore volume of from 300 cm³/g to 500 cm³/g, from 300 cm³/g to 450 cm³/g, from 300 cm³/g to 400 cm³/g, from 350 cm³/g to 500 cm³/g, from 350 cm³/g to 450 cm³/g, or from 350 cm³/g to 400 cm³/g.

In some embodiments, the mesoporous beta zeolite produced by previously described processes may be used as a catalyst in a fluidized catalytic cracking (FCC) reactor. The reactor may be a fluidized bed reactor. In the reactor, the catalyst comprising the mesoporous beta zeolite may be contacted with the crude oil in the presence of steam to produce light olefin. In some embodiments, the catalyst consists of the mesoporous beta zeolite. Examples of suitable processes for catalytically cracking crude oil in the presence of steam are disclosed in U.S. patent application Ser. No. 17/009,008, U.S. patent application Ser. No. 17/009,012, U.S. patent application Ser. No. 17/009,020, U.S. patent application Ser. No. 17/009,022, U.S. patent application Ser. No. 17/009,039, U.S. patent application Ser. No. 17/009,048, and U.S. patent application Ser. No. 17/009,073, all of which are incorporated by reference in their entireties.

In some embodiments, the crude oil may have a relatively great API gravity, such as at least 30 degrees, and often greater than 50 degrees. In some embodiments, the crude oil may have an API gravity of at least about 30 degrees, at least 35 degrees, at least 40 degrees, at least 45 degrees, at least 50 degrees, at least 55 degrees, or even at least 60 degrees.

In some embodiments, the crude oil may have a boiling point profile as described by the 5 wt. % boiling temperature, the 25 wt. % boiling temperature, the 50 wt. % boiling temperature, the 75 wt. % boiling temperature, and the 95 wt. % boiling temperature. These respective boiling temperatures correspond to the temperature at which a given weight percentage of the hydrocarbon feed stream boils. In some embodiments, the crude oil may have one or more of a 5 wt. % boiling temperature of less than 150° C., a 25 wt. % boiling temperature of less than 225° C., a 50 wt. % boiling temperature of less than 300° C., a 75 wt. % boiling temperature of less than 400° C., and a 95 wt. % boiling temperature of less than 600° C. In some embodiments, the crude oil may have one or more of a 5 wt. % boiling temperature of from 0° C. to 100° C., a 25 wt. % boiling temperature of from 75° C. to 175° C., a 50 wt. % boiling temperature of from 150° C. to 250° C., a 75 wt. % boiling temperature of from 250° C. to 350° C., and a 95 wt. % boiling temperature of from 450° C. to 550° C.

In some embodiments, the reactor may be operated at a temperature of at least about 500° C. In some embodiments, the reactor may be operated at a temperature of from 500° C. to 800° C., from 550° C. to 800° C., from 600° C. to 800° C., from 650° C. to 800° C., from 500° C. to 750° C., from 550° C. to 750° C., from 600° C. to 750° C., from 650° C. to 750° C., from 500° C. to 700° C., from 550° C. to 700° C., from 600° C. to 700° C., or from 650° C. to 700° C.

In some embodiments, steam may be injected to the reactor. The crude oil may be catalytically cracked in the presence of the steam with the mesoporous beta zeolite. Steam may act as a diluent to reduce a partial pressure of the hydrocarbons in the crude oil. The steam to the crude oil mass ratio may be from 0.2 to 1.0, from 0.3 to 1.0, from 0.4 to 1.0, from 0.5 to 1.0, from 0.2 to 0.8, from 0.3 to 0.8, from 0.4 to 0.8, from 0.5 to 0.8, from 0.2 to 0.7, from 0.3 to 0.7, from 0.4 to 0.7, from 0.5 to 0.7, from 0.2 to 0.6, from 0.3 to 0.6, from 0.4 to 0.6, or from 0.5 to 0.6. Steam may refer to all H₂O in the steam.

In some embodiments, the residence time of the crude oil and the steam may be from 1 second to 20 seconds, from 2 seconds to 20 seconds, from 5 seconds to 20 seconds, from 8 seconds to 20 seconds, from 1 second to 18 seconds, from 2 seconds to 18 seconds, from 5 seconds to 18 seconds, from 8 seconds to 18 seconds, from 1 second to 16 seconds, from 2 seconds to 16 seconds, from 5 seconds to 16 seconds, from 8 seconds to 16 seconds, from 1 second to 14 seconds, from 2 seconds to 14 seconds, from 5 seconds to 14 seconds, from 8 seconds to 14 seconds, from 1 second to 12 seconds, from 2 seconds to 12 seconds, from 5 seconds to 12 seconds, or from 8 seconds to 12 seconds.

In some embodiments, the mesoporous beta zeolite to crude oil weight ratio may be from 7 to 50, from 7.5 to 50, from 8 to 50, from 7 to 45, from 7.5 to 45, from 8 to 45, from 7 to 40, from 7.5 to 40, or from 8 to 40.

In some embodiments, the contacting of the crude oil with the mesoporous beta zeolite in the presence of the steam produces a product stream that may comprise at least 30 wt. % of light olefins selected from ethylene, propylene, and butene. For example, in embodiments, the product stream may comprise at least 35 wt. % of light olefins, at least 38 wt. % of light olefins, or at least 40 wt. % of light olefins. In some embodiments, the product stream may comprise at least 10 wt. % of ethylene, at least 12 wt. % of ethylene, at least 15 wt. % of ethylene, or even at least 16 wt. % of ethylene, at least 10 wt. % of propylene, at least 12 wt. % of propylene, at least 13 wt. % of propylene, or even at least 14 wt. % of propylene, at least 5 wt. % of butene, at least 6 wt. % of butene, at least 7 wt. % of butene, or even at least 8 wt. % of butane.

### EXAMPLES

The various embodiments of methods for producing hierarchical mesoporous beta zeolites will be further clarified by the following examples. The examples are illustrative in nature, and should not be understood to limit the subject matter of the present disclosure.

### Example 1: Production of Mesoporous Beta Zeolite

In a glass reactor, 7 grams of a crystalline beta zeolite (CP-814C) having the molar ratio of silicon to aluminum of 38 was mixed with 0.40 M sodium hydroxide (NaOH) solution. 4.45 wt. % of cetyltrimethylammonium bromide (CTAB) was also mixed with the crystalline beta zeolite and NaOH solution to produce a solution. The solution was heated with stirring at 100° C. for 24 hours to convert the crystalline beta zeolite to a non-crystalline material with reduced silica content. The heated solution was cooled down to a temperature of from 25° C. to 40° C. A pH of the cooled solution was adjusted to 9.0 through the addition of dilute sulfuric acid (2N). The solution was stirred for 24 hours and then aged at 100° C. for 24 hour to crystalize the non-crystalline material to produce beta zeolite particles. The beta zeolite particles were filtered, washed thoroughly using distilled water, and then dried at 80° C. overnight. The dried beta zeolite particles were calcined at 570° C. for 6 hours to remove CTAB. The calcined beta zeolite particles were treated with 0.25 N ammonium nitrate (NH₄NO₃) solution twice at 80° C. for 5 hours to produce mesoporous beta zeolite.

### Example 2: Produce Mesoporous Beta Zeolite

In a glass reactor, 7 grams of a crystalline beta zeolite (HSZ-940 NHA) having the molar ratio of silicon to aluminum of 40 was mixed with 0.40 M sodium hydroxide (NaOH) solution. 4.45 wt. % of cetyltrimethylammonium bromide (CTAB) was also mixed with the crystalline beta zeolite and NaOH solution to produce a solution. The solution was heated with stirring at 100° C. for 24 hours to convert the crystalline beta zeolite to a non-crystalline material with reduced silica content. The heated solution was cooled down to a temperature of from 25° C. to 40° C. A pH of the cooled solution was adjusted to 9.0 through the addition of dilute sulfuric acid (2N). The solution was stirred for 24 hours and then aged at 100° C. for 24 hour to crystalize the non-crystalline material to produce beta zeolite particles. The beta zeolite particles were filtered, washed thoroughly using distilled water, and then dried at 80° C. overnight. The dried beta zeolite particles were calcined at 570° C. for 6 hours to remove CTAB. The calcined beta zeolite particle s were treated with 0.25 N ammonium nitrate (NH₄NO₃) solution twice at 80° C. for 5 hours to produce mesoporous beta zeolite.

### Example 3: Produce Mesoporous Beta Zeolite

In a glass reactor, 7 grams of a crystalline beta zeolite (CP-811C) having the molar ratio of silicon to aluminum of 300 was mixed with 0.40 M sodium hydroxide (NaOH) solution. 4.45 wt. % of cetyltrimethylammonium bromide (CTAB) was also mixed with the crystalline beta zeolite and NaOH solution to produce a solution. The solution was heated with stirring at 100° C. for 24 hours to convert the crystalline beta zeolite to a non-crystalline material with reduced silica content. The heated solution was cooled down to a temperature of from 25° C. to 40° C. A pH of the cooled solution was adjusted to 9.0 through the addition of dilute sulfuric acid (2N). The solution was stirred for 24 hours and then aged at 100° C. for 24 hour to crystalize the non-crystalline material to produce beta zeolite particles. The beta zeolite particles were filtered, washed thoroughly using distilled water, and then dried at 80° C. overnight. The dried beta zeolite particles were calcined at 570° C. for 6 hours to remove CTAB. The calcined beta zeolite particle s were treated with 0.25 N ammonium nitrate (NH₄NO₃) solution twice at 80° C. for 5 hours to produce mesoporous beta zeolite.

### Comparative Example 1

A mixture including 75 wt. % of Equilibrium Catalyst (ECAT) and 25 wt. % of ZSM-5 (commercially available as OlefinsUltra® from W.R. Grace and Company) (referred to as “UMIX75”) was prepared.

### Example 4: Steam Enhanced Fluidized Catalytic Cracking Testing

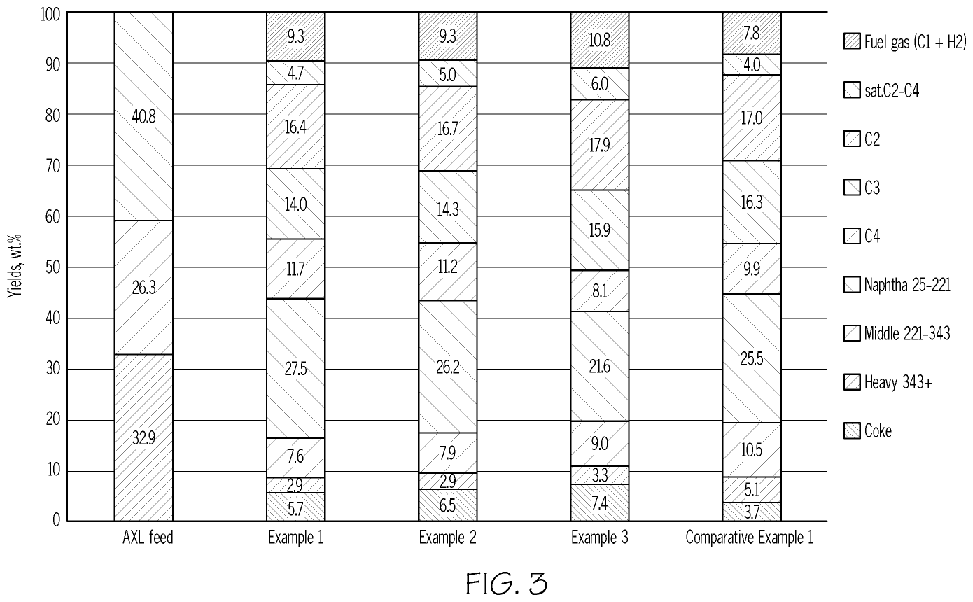

Example 4 provides data related to the cracking of crude oil in the presence of steam with Examples 1-3 and Comparative Example 1. Experiments were carried out at atmospheric pressure in a fixed-bed reaction (FBR) system in the presence of steam and the absence of steam with Arabian Extra Light (AXL) crude oil as feed. Referring to FIG. 2, AXL crude oil 301 was fed to a fixed-bed reactor 30 using a metering pump 311. A constant feed rate of 2 g/h of AXL crude oil 301 was used. Water 302 was fed to the reactor 30 using a metering pump 312. Water 302 was preheated using a preheater 321. A constant feed rate of 1 g/h of water 302 was used. Nitrogen 303 was used as a carrier gas at 65 mL/min. Nitrogen 303 was fed to the reactor 30 using a Mass Flow Controller (MFC) 313. Nitrogen 303 was preheated using a preheater 322. Water 302 and Nitrogen 303 were mixed using a mixer 330 and the mixture was introduced to the reactor 30. Prior to entering the reactor tube, oil, water, and nitrogen were preheated up to 250° C. in the pre-heating zone 342. The pre-heating zone 342 was pre-heated using line heaters 331. Crude oil 301 was introduced from the top of the reactor 30 through the injector 341 and mixed with steam in the top two-third of the reactor tube 340 before reaching the catalyst bed 344. The mass ratio of steam: crude oil was 0.5. The crude oil was cracked at a cracking temperature of 675° C. and a weight ratio of catalyst to oil of 1:2. The residence time of the crude oil and the steam in the reactor was 10 seconds. Each of Examples 1-3 and Comparative Example 1 was used as a cracking catalyst. 1 g of cracking catalyst of 30-40 mesh size was placed at the center of the reactor tube 340, supported by quartz wool 343, 346 and a reactor insert 345. Quartz wool 343, 346 were placed both at the bottom and top of the catalyst bed 344 to keep it in position. The height of the catalyst bed 344 was 1-2 cm. The reaction was allowed to take place for 45-60 min, until steady state was reached. Reaction conditions of the fixed-bed flow reactor 30 are listed in Table 1. The cracking reaction product stream was introduced to a gas-liquid separator 351. A Wet Test Meter 352 was placed downstream of the gas-liquid separator 351. The cracked gaseous products 361 and liquid products 362 were characterized by off-line gas chromatographic (GC) analysis using simulated distillation and naphtha analysis techniques. The reaction product streams from the cracking reaction were analyzed for yields of ethylene, propylene, and butylene. The yield analyses for Example 4 are depicted in FIG. 3.

TABLE 1

| Conditions | |
|---|---|
| Feed Used | AXL Whole Crude |
| Specific gravity of feedstock | 0.829 |
| API | 39.3 |
| Reaction apparatus | Fixed Bed Reactor |
| Weight hourly space velocity | 3 |
| Reaction temperature, ° C. | 675 |
| Reaction temperature Range, ° C. | 600-700 |

As shown in FIG. 3, the yield of ethylene of Example 3 (17.9 wt. %) was greater than those of Comparative Example 1 (17.0 wt. %). Further, the yield of ethylene and propylene of Example 3 (33.8 wt. %) was greater than those of Comparative Example 1 (33.3 wt. %). These results show that the catalyst in Example 3 is much more selective towards ethylene, and ethylene and propylene compared to Comparative Example 1. Moreover, the yield of butylene of Example 1 (11.7 wt. %) and Example 2 (11.2 wt. %) were greater than those of Comparative Example 1 (9.9 wt. %) while providing selective toward ethylene, propylene, or ethylene and propylene. Also, the catalysts in Examples 1-3 showed abilities to withstand high hydrothermal conditions, while retaining its activity and selectivity.

A first aspect of the present disclosure may be directed to a process of producing a mesoporous beta zeolite comprising mixing a crystalline beta zeolite with one or more solvents, cetyltrimethylammonium bromide (CTAB), and metal hydroxide to produce a solution, heating the solution at a temperature of from 50° C. to 150° C. to convert the crystalline beta zeolite to a non-crystalline material with reduced silica content relative to the crystalline beta zeolite, cooling the solution to a temperature of from 25° C. to 40° C., adjusting a pH of the solution to from 8 to 10 by adding an acid, and aging the solution at a temperature of from 50° C. to 150° C. for a time period sufficient to crystalize the non-crystalline material to produce beta zeolite particles.

A second aspect of the present disclosure may include the first aspect, further comprising filtering the beta zeolite particles from the solution.

A third aspect of the present disclosure may include either one of the first or second aspects, further comprising washing the beta zeolite particles through distilled water.

A fourth aspect of the present disclosure may include any one of the first through third aspects, further comprising drying the beta zeolite particles at a temperature of from 50° C. to 150° C.

A fifth aspect of the present disclosure may include any one of the first through fourth aspects, further comprising calcining the beta zeolite particles at a temperature of from 500° C. to 600° C. for 1 to 12 hours to remove CTAB.

A sixth aspect of the present disclosure may include any one of the first through fifth aspects, further comprising treating the beta zeolite particles with ammonium salt a temperature of from 70° C. to 90° C. for 1 to 12 hours.

A seventh aspect of the present disclosure may include any one of the first through sixth aspects, wherein the treating step comprises in a first step, treating the beta zeolite particles with the ammonium salt at a temperature of from 70° C. to 90° C. for 1 to 12 hours, and in a second step following the first step, treating the beta zeolite particles with the ammonium salt at a temperature of from 70° C. to 90° C. for 1 to 12 hours to produce the mesoporous beta zeolite.

An eighth aspect of the present disclosure may include any one of the first through seventh aspects, wherein the ammonium salt comprises ammonium nitrate, ammonium chloride, ammonium sulfate, ammonium carbonate, or combinations thereof.

A ninth aspect of the present disclosure may include any one of the first through eighth aspects, wherein the ammonium salt is in a solution and comprises a concentration of from 0.05 M to 0.5 M.

A tenth aspect of the present disclosure may include any one of the first through ninth aspects, wherein the crystalline beta zeolite comprises an average crystal size of from 0.1 micrometer (μm) to 1.4 μm.

An eleventh aspect of the present disclosure may include any one of the first through tenth aspects, wherein the crystalline beta zeolite comprises a molar ratio of silica to alumina of from 30 to 350.

A twelfth aspect of the present disclosure may include any one of the first through eleventh aspects, wherein the metal hydroxide is in a solution and comprises a concentration from 0.01 moles per liter (M) to 5 M.

A thirteenth aspect of the present disclosure may include any one of the first through twelfth aspects, wherein the metal hydroxide comprises lithium hydroxide (LiOH), sodium hydroxide (NaOH), potassium hydroxide (KOH), rubidium hydroxide (RbOH), magnesium hydroxide (Mg(OH)₂), calcium hydroxide (Ca(OH)₂), strontium hydroxide (Sr(OH)₂), barium hydroxide (Ba(OH)₂), or combinations thereof.

A fourteenth aspect of the present disclosure may include any one of the first through thirteenth aspects, wherein the mesoporous beta zeolite comprises an average particle size of from 0.4 μm to 1.1 μm.

A fifteenth aspect of the present disclosure may include any one of the first through fourteenth aspects, wherein the mesoporous beta zeolite comprises a total pore volume of from 0.5 cubic centimeters per gram (cm³/g) to 0.8 cm³/g.

A sixteenth aspect of the present disclosure may include any one of the first through fifteenth aspects, wherein the mesoporous beta zeolite comprises a Brunauer-Emmett-Teller (BET) surface area of 450 square meters per gram (m²/g) to 700 m²/g.

A seventeenth aspect of the present disclosure may include any one of the first through sixteenth aspects, wherein the mesoporous beta zeolite comprises an average mesopore size of from 3 nm to 20 nm and an average micropore size of from 0.5 nm to 2.0 nm.

An eighteenth aspect of the present disclosure may be directed to a process of cracking crude oil comprising contacting the crude oil with a mesoporous beta zeolite in a fluidized bed reactor, wherein the mesoporous beta zeolite is produced by the processes of any one of the first through seventeenth aspects.

A nineteenth aspect of the present disclosure may include any one of the first through eighteenth aspects, further comprising injecting steam in to the reactor, wherein the steam to the crude oil mass ratio of from 0.2 to 1.0.

A twentieth aspect of the present disclosure may include any one of the first through nineteenth aspects, wherein the mesoporous beta zeolite to the crude oil weight ratio is from 7 to 40.

It is noted that one or more of the following claims utilize the term “wherein” or “in which” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

What is claimed is:

1. A process of producing a mesoporous beta zeolite, the process comprising:
mixing a crystalline beta zeolite with one or more solvents, cetyltrimethylammonium bromide (CTAB), and metal hydroxide to produce a solution;
heating the solution at a temperature of from 50° C. to 150° C. to convert the crystalline beta zeolite to a non-crystalline material with reduced silica content relative to the crystalline beta zeolite;
cooling the solution to a temperature of from 25° C. to 40° C.;
adjusting a pH of the solution to from 8 to 10 by adding an acid; and
aging the solution at a temperature of from 50° C. to 150° C. for a time period sufficient to crystalize the non-crystalline material to produce beta zeolite particles.

2. The process of claim 1, further comprising filtering the beta zeolite particles from the solution.

3. The process of claim 1, further comprising washing the beta zeolite particles through distilled water.

4. The process of claim 1, further comprising drying the beta zeolite particles at a temperature of from 50° C. to 150° C.

5. The process of claim 1, further comprising calcining the beta zeolite particles at a temperature of from 500° C. to 600° C. for 1 to 12 hours to remove CTAB.

6. The process of claim 1, further comprising treating the beta zeolite particles with ammonium salt a temperature of from 70° C. to 90° C. for 1 to 12 hours.

7. The process of claim 6, wherein the treating step comprises:
in a first step, treating the beta zeolite particles with the ammonium salt at a temperature of from 70° C. to 90° C. for 1 to 12 hours; and
in a second step following the first step, treating the beta zeolite particles with the ammonium salt at a temperature of from 70° C. to 90° C. for 1 to 12 hours to produce the mesoporous beta zeolite.

8. The process of claim 6, wherein the ammonium salt comprises ammonium nitrate, ammonium chloride, ammonium sulfate, ammonium carbonate, or combinations thereof.

9. The process of claim 6, wherein the ammonium salt is in a solution and comprises a concentration of from 0.05 M to 0.5 M.

10. The process of claim 1, wherein the crystalline beta zeolite comprises an average crystal size of from 0.1 micrometer (μm) to 1.4 μm.

11. The process of claim 1, wherein the crystalline beta zeolite comprises a molar ratio of silica to alumina of from 30 to 350.

12. The process of claim 1, wherein the metal hydroxide is in a solution and comprises a concentration from 0.01 moles per liter (M) to 5 M.

13. The process of claim 1, wherein the metal hydroxide comprises lithium hydroxide (LiOH), sodium hydroxide (NaOH), potassium hydroxide (KOH), rubidium hydroxide (RbOH), magnesium hydroxide (Mg(OH)₂), calcium hydroxide (Ca(OH)₂), strontium hydroxide (Sr(OH)₂), barium hydroxide (Ba(OH)₂), or combinations thereof.

14. The process of claim 1, wherein the mesoporous beta zeolite comprises an average particle size of from 0.4 μm to 1.1 μm.

15. The process of claim 1, wherein the mesoporous beta zeolite comprises a total pore volume of from 0.5 cubic centimeters per gram (cm³/g) to 0.8 cm³/g.

16. The process of claim 1, wherein the mesoporous beta zeolite comprises a Brunauer-Emmett-Teller (BET) surface area of 450 square meters per gram (m²/g) to 700 m²/g.

17. The process of claim 1, wherein the mesoporous beta zeolite comprises an average mesopore size of from 3 nm to 20 nm and an average micropore size of from 0.5 nm to 2.0 nm.

18. A process of cracking crude oil, the process comprising contacting the crude oil with a mesoporous beta zeolite in a fluidized bed reactor, wherein the mesoporous beta zeolite is produced by the processes of claim 1.

19. The process of claim 18, further comprising injecting steam in to the reactor, wherein the steam to the crude oil mass ratio of from 0.2 to 1.0.

20. The process of claim 18, wherein the mesoporous beta zeolite to the crude oil weight ratio is from 7 to 40.
